(19) United States
(12) Patent Application Publication
(10) Pub. No.: US 2006/0010152 A1
(43) Pub. Date: Jan. 12, 2006

(54) System and method for managing machine servicing including workscope generation

(75) Inventors: Matthieu Catalano, Montigny Le Bretonneux (FR); Yves Crochemore, Palaiseau (FR); Dominique Llorens-Cortes, Bures Sur Yvette (FR); Henri Marie-Agnes, Chatellerault (FR); Didier Rodrigue, Chatellerault (FR)

Correspondence Address: CONNOLLY BOVE LODGE & HUTZ LLP;(CABINET BEAU DE LOMENIE), 1990 M STREET NW, SUITE 800, WASHINGTON, DC, 20036-3425, US

(73) Assignee: SNECMA Services, Paris (FR)

(21) Appl. No.: 10/887,928

(22) Filed: Jul. 12, 2004

(51) Int. Cl. G06F 17/00

(52) U.S. Cl. 707/102

(57) ABSTRACT

The present invention relates to management of machine servicing, particularly, but not only, aircraft engine servicing. When a machine is received in a service facility for one of a plurality of predefined reasons, repair and/or maintenance procedures known to correspond to that reason are identified and a workscope defining work to be performed is generated. It is desirable (but not required according to the present invention) to identify what parts and/or tools will be needed to carry out the repair and/or maintenance procedures. It is additionally desirable to permit the parts and/or tools to be ordered or otherwise requested in anticipation of carrying out the defined work. The workscope can be enhanced by taking into account work (required or not) that is customarily performed for a given client. A cost estimate corresponding to the workscope may also be generated, and may also be modified according to client-specific parameters such as the nature of the client's service contract

### BACKGROUND OF THE INVENTION

Machine servicing (which broadly encompasses both maintenance and repair work) presents difficult logistical problems when efficient and economical operations are sought. The logistical problems are frequently magnified by the complexity of the machine in question.

In general, a machine presents the best economic value to its owner/operator when it is actually in operation. It is therefore clear that service work must be carried out as quickly and efficiently as possible in order to minimize the amount of time that the machine is inoperative. Also, service work must be organized carefully in order to avoid unwanted delays or other problems, such as waiting for parts, tools, personnel, or workspace needed to complete the desired work.

Service work also frequently requires secondary or otherwise complimentary work that must be organized and planned with respect to the service work. For example, if a component physically located deep within a machine is to be serviced, certain additional disassembly steps involving areas of the machine unrelated to the component may be necessary to allow access to the component. In particular, this secondary work may require a combination of tools, parts, and/or even specialized labor that may be completely unrelated to the original work to be performed on the target component.

As mentioned above, service work is meant to encompass both repair work and maintenance work. Maintenance work includes regular (in a timewise sense) maintenance requirements. It is therefore desirable to take such regular maintenance schedules into account when performing, for example, unexpected or otherwise unscheduled service work, such as repairs. For example, it would be undesirable to take machinery out of service (“off-line”) to perform repair work, only to have to take it out of service again shortly thereafter to perform scheduled maintenance. Depending on when the next scheduled maintenance is to occur and what kind of repair work is to be done, it may be preferable to do the repair and maintenance work at the same time.

Similarly, machinery may be occasionally subject to mandatory or recommended servicing (sometimes referred to herein as general work) not envisioned at the time the machinery was placed into operation. Regulatory authorities or manufacturers alike may disseminate these requirements or recommendations. For example, in the field of aviation, relevant government authorities (such as the Direction Generale de l'Aviation Civile in France, the Federal Aviation Administration in the United States, or the Civil Aviation Authority in the United Kingdom) sometimes issue directives (which are sometimes known in the art as airworthiness directives) describing certain technical changes or refits to be made either on a mandatory or on a suggested basis. The work set forth in such directives is sometimes based on recently discovered information, such as previously undiscovered design faults discovered in the course of an accident investigation. The directives also frequently indicate how immediately the work needs to be done, ranging, for example, from immediately (for immediate threats to operational safety, for example) to at the next scheduled overhaul (for long term problems like slow wear, for example).

As mentioned above, other repair and/or maintenance procedures may be disseminated by the machinery manufacturer itself by way of service bulletins and the like. For example, a manufacturer may discover that a previously defined repair procedure has unanticipated results, such as causing excessive part wear or being burdensomely complicated in practice. The manufacturer may therefore develop and disseminate an “improved” procedure to operators of the machinery. Also, service bulletins identify particular parts or assemblies that should be, or may advantageously be, replaced by newly designed parts or assemblies to improve, for example, performance, safety, operating life, etc.

Thus, both regulatory directives and service bulletins must also be taken into account in planning service work on a machine, just as scheduled maintenance must be (as mentioned above) in order to avoid taking machinery “off-line” repeatedly.

Preplanning service work is also very important with respect to estimating the cost of providing the service. In particular, a complete estimate of all work that must be done must be obtained in order to be able to provide an accurate cost estimate to a customer. Cost estimates are frequently binding, or at least have very little flexibility. Therefore, failing to plan for all necessary work results in lost revenue opportunities and even increased expenses for the service provider who probably has to absorb the revenue loss for unbilled work and materials. An important example of this problem is, as mentioned above, when certain complimentary procedures must be performed in order to perform the desired work. In planning for a specific task, required complimentary procedures may be forgotten or otherwise overlooked. The costs for the complimentary work on the machine (with respect to both labor and materials) are therefore not included or are not completely included in the final estimate of costs provided to the customer.

Another factor to be considered in cost estimation is that different types of client service contracts affect estimation methodologies. That is, the most desirable and/or most relevant estimate is not necessarily the least expensive estimate for only the specifically desired work, for reasons mentioned above. For example, other procedures, such as regular scheduled maintenance, may be scheduled in such close proximity that a judgment can be made that it would be wasteful to take the machinery out of service two separate times. Also, it may be desirable, but not necessary, to perform other types of service concurrent with the original work to be done.

A significant factor to consider is differences between service contracts. In the field of aviation, for example, one might operate either under an hours-in-air contract or a time-and-materials contract.

In the former example, the goal is to maximize operations between servicing (in the case of engines, for example, maximizing the time under the wing). Thus, it is not necessarily desirable to select the minimum level of work possible. Instead, the ideal solution in such a situation sometimes entails performing more than a minimum level of work at a commensurately higher than minimum cost, so that the operational period between servicing can be extended. On the other hand, in a time-and-materials contract, the primary consideration is labor and materials costs, so minimizing these costs becomes desirable.

Also, even when repair and maintenance is well-planned, it is challenging, and even inconvenient, to project and procure what materials will be needed to carry out the anticipated work, especially with respect to tools and parts. It would therefore be useful to be able to easily judge what parts and tools are needed for a given work project.

### SUMMARY OF THE INVENTION

In view of the foregoing, the present invention relates to a method and system for automatic management of machine servicing, particularly, but not exclusively, repair and maintenance therefor. In a particular example, the present invention relates to managing service work performed in a service facility, although the present invention is equally applicable to onsite service work. In another particular example, the present invention relates to the management of service work from a centralized point with respect to a plurality of service facilities of a service providing company. The present invention is, for example, useful in the service of aircraft engines, whether performed at a service facility or onsite (sometimes referred to as “on wing support”). Moreover, a particular example of the present invention relates to servicing aircraft engines. However, the present invention generally relates to service work performed on any machine.

More particularly, the present invention relates to automatically generating a workscope in which at least all work that must be performed (as well as, depending on circumstances and needs, work that should be performed) is identified.

The workscope according to the present invention desirably also identifies secondary (sometimes referred to herein as “complimentary”) work procedures (either antecedent or subsequent) that may not be directly related to a particular main task, but which, for example, may permit the main task to be undertaken or be better completed. For example, if the main task were repairing an initially inaccessible machine component in a machine, a complimentary antecedent procedure would include disassembly steps permitting the component to be accessed for repair.

Although certain parts of the workscope can be generated based on stored data corresponding to a model machine, it is desirable to actually consider a specific actual machine, for example, with respect to its operational life history. This permits machine-specific factors (such as age-dependent or environment-specific maintenance) to be identified.

According to the present invention, a cost estimate corresponding to the generated workscope can also be generated. The cost estimate may include or be based upon any commercially useful combination of factors. The cost estimate may be based on a cost for parts and materials and a cost for labor, for example. Preferably, the cost estimate is modified appropriately in view of client-specific factors, including, for example, the nature of the client's service contract or usual (i.e., in view of past experience) client preferences.

Other beneficial management decisions can be based on the workscope, such as tool and material provisioning and personnel scheduling.

A system in accordance with the present invention may be embodied, for example and without limitation, in a single PC computer, or in client-server arrangement on a computer network. In one example, one or more computer servers may be connected to a plurality of workstation clients located in various parts of a service facility (e.g., a parts department, a tool storage, an accounting department, a sales/client relations department, an actual service area, service facilities in several geographic locations) so that different relevant personnel can access the workscope generating system. Appropriate data communication links can be established in order to permit parts and/or materials to be ordered from supply sources. Thus, the present invention could, for example, be incorporated into a just-in-time supply system.

### BRIEF DESCRIPTION OF THE DRAWINGS

The present invention will be even better understood with reference to the figures attached hereto, in which:

FIG. 1 is a flow chart broadly illustrating a method of generating a workscope according to the present invention;

FIG. 2 is a flow chart illustrating a variant of the method illustrated in FIG. 1;

FIG. 3 is a flow chart illustrating a further variant of the methods illustrated in FIGS. 1 and 2;

FIG. 4 illustrates conceptual relationships of the present invention;

FIG. 5 schematically illustrates how a model machine can be hierarchically deconstructed at several levels, culminating in cross-indexing with identifiable machine parts;

FIG. 6 illustrates how a given part of a modeled machine can be associated with one or more possible service operations that are selected according to one or more reasons for servicing the machine, and furthermore, how a given service operation can linked to one or more machine parts;

FIG. 7 is a flow chart illustrating an example of a process of inspecting a machine assembly and determining work to be done in accordance with various decision points in the inspection process;

FIG. 8 illustrates several examples of downstream business applications based on the generation of a workscope according to the present invention; and

FIG. 9 illustrates an example of a system for generating workscopes according to the present invention.

The figures are strictly illustrative in nature, and are meant merely to illustrate the invention disclosed and claimed herein by way of examples, without being in and of themselves limitative.

### DETAILED DESCRIPTION OF THE PRESENT INVENTION

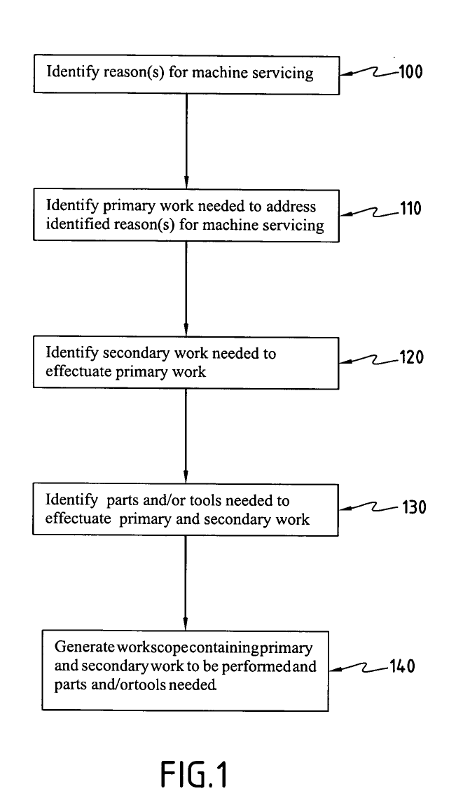

A method of generating a workscope according to the present invention is illustrated broadly in FIG. 1.

When a machine is to be serviced, the reason or reasons for servicing the machine are initially identified, as indicated at 100. Examples of such reasons include, without limitation, scheduled maintenance, performance problems or machine failure with known or unknown causes, mandatory unscheduled service work required by governmental regulatory agencies, recommended unscheduled service work suggested by governmental regulatory agencies or the machine manufacturer, repairs necessitated by acute damage, and repairs necessitated by parts deterioration.

It can be appreciated that more than one reason for servicing can exist at any given time. In one example, performance problems involving a first part of the machine may be present at a time when scheduled maintenance involving a second part of a machine is due.

Once the reason or reasons for performing service are identified, the corresponding work that must be performed to address those reasons (i.e., the primary work) is identified, as indicated at 110. In the simplified example above, the primary work would consist of, broadly, addressing the performance problems in the first part of the machine and completing the scheduled maintenance involving the second part of the machine.

Thus a given reason for performing service may require performing one or more tasks to address the reason for performing service. In a general illustrative example, a process of replacing a turbine rotor includes, for example, the tasks of unfastening the rotor, removing the rotor, moving a replacement rotor into place, and fastening the replacement rotor into place.

In turn, each task consists of one or more work procedures, each work procedure consisting of one or more specific actions to be taken by service personnel. In the foregoing example of replacing a turbine rotor, the task of fastening a replacement rotor into place, for example, may consist of the actions of manually positioning a plurality of bolts, machine fastening the bolts with a desired torque, and manually inspecting each bolt to ensure good tightening.

In general, the level of detail offered in the definitions of tasks, work procedures, and actions is commensurate with a general level of knowledge. It is desirable to provide enough clear and detailed information to service personnel to avoid any confusion or mistakes in performing the required work. However, it is equally important to avoid overwhelming service personnel with unnecessarily detailed information by making certain reasonable and realistic assumptions regarding a basic level of knowledge.

The reasons for service and the corresponding primary work to be performed may be interrelated by any known indexing or data record linking method.

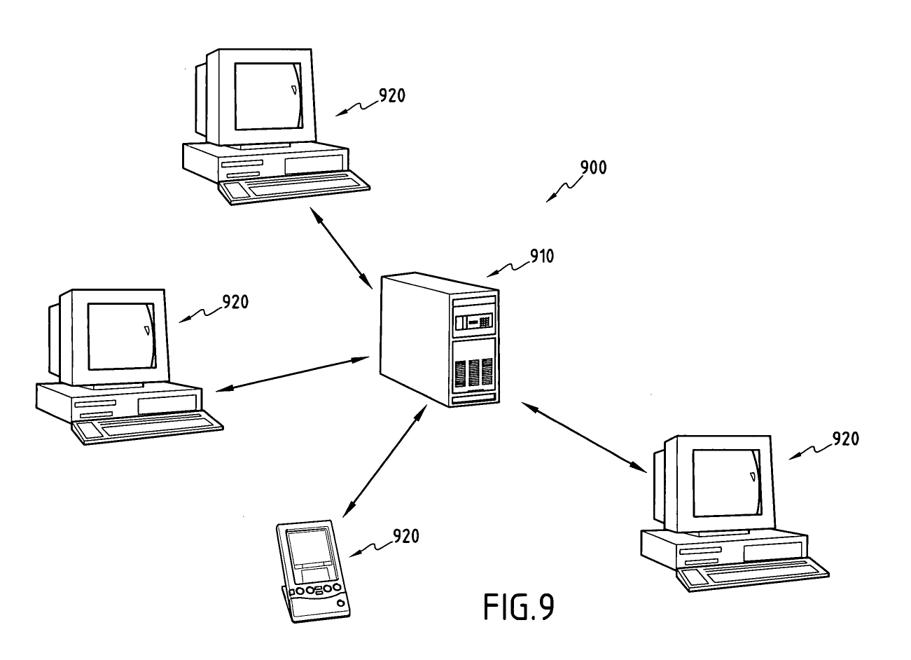

In one example, a set of reasons for servicing is predefined and stored in a conventional computerized database. (See also the discussion below with respect to FIG. 9.) Preferably, the scope of the predefined reasons for service is sufficiently broad so as to encompass most foreseeable reasons for servicing the machine. The reason(s) for servicing a given machine may be identified by, for example, manual user selection or by an automated process of identifying reason(s) for servicing). In an example of the present invention, 10 to 30 different reasons for servicing may be predefined.

Likewise, the corresponding work to be performed may be stored in a computerized database. In addition, the structure of the machine, including all of its constituent assemblies, modules, parts, and the like is modeled and stored on a database. The structure of the machine information is made available for interaction with one or both of the reasons for service information and the work to be performed information. The structure of the machine information may be in the form of an Illustrated Parts Catalog (IPC), a known form of organizing such information that is sometimes used with complex systems based on coding parts and assemblies of parts according to a standardized system.

Most generally, the respective groups of information are linked using known database algorithms in a manner such that a given reason for service is automatically linked with the all the work judged necessary to address that reason for service. The work to be performed information may be organized in any useful manner. For example, the work to be performed data may be hierarchically organized, for example, using the task/work procedure/action hierarchy. Accordingly, for a given reason for service, a first result might be generated in terms of tasks to be performed, so as to be able to envision the work at a macro level. Each identified task to be performed could be further broken down in terms of work procedures, and further in terms of specific actions. Preferably, a user can change between levels at will, so as to be better able to visualize the work that is needed. Also, it may be useful to generally contemplate the work to be performed in terms of tasks, breaking down one task at a time as needed down to the corresponding collection of actions.

It should be recalled, however, that a given work procedure (e.g., degrease metal surface) may be associated with more than one task, and a given service personnel action (e.g., tighten screw) may be associated with more than one work procedure. Therefore, the stored data should preferably be arranged (e.g., cross-linked) to take this into account.

As mentioned above, any given task identified as part of the primary work to be performed will frequently require other work or activity that will, most importantly, permit the primary work to be performed. This work or activity either must be performed or may be performed, depending on the situation. This other work is sometimes referred to herein as “secondary work” in that it has no direct relation to the primary work except that it permits the primary work to be performed, or it permits the primary work to be performed more easily, efficiently, less expensively, less dangerously, etc. For example, if the primary work relates to a component physically located deep within a machine, secondary work consisting of, for example, disassembling the overlying structure of the machine to permit access to the component may be necessary.

In an example of the present invention, task-level primary work information can be linked to corresponding secondary work information using conventional database/data processing methods. Thus, when certain tasks are identified as necessary primary work, the secondary work corresponding thereto can be concurrently identified, as indicated at 120. Secondary work that must be performed (for example, clearing access to a component to be worked upon) may be said to be “implied” by the primary work in question.

Having identified the primary and secondary work to be performed, it is useful, but not absolutely necessary, to additionally identify anything else that may be needed to efficiently effectuate the identified primary and secondary work. In particular, as indicated at 130 by way of example, the present invention contemplates identifying spare parts and/or tools that are needed to perform the required work. It will be appreciated that other factors could also be usefully identified, such as specially-skilled personnel, special environmental controls, etc. These types of information can also be stored in a database in a known manner and linked to a given type work so as to be retrieved in correspondence with any given type of work to be performed.

The collection of information from blocks 110, 120, and 130, organized in any desirable manner, results in the workscope according to the present invention, as indicated at 140. In one example, the information is organized in sequential manner, ultimately in terms of a series of actions that are properly sequenced as between the primary and secondary work. In another example, the work to be performed may be concisely expressed in terms of a collective work procedure label corresponding to a different technical situation plus certain additional and individually identified steps called for in response to a currently considered technical situation. In yet another example, the work to be performed may be expressed in terms of a combination of collective work procedure labels (each corresponding to one or more specific actions). In yet another example, the work to be performed may be expressed in any reasonable combination of individually listed actions, collective work procedures, and combinations of a defined work procedure plus certain additional actions.

The information may be appropriately annotated or otherwise supplemented with useful notations concerning, for example and without limitation, proper tools to be used, recommended safety procedures, warnings about unobvious hazards, etc. The collected information can be presented in any desirable format using any suitable known mechanism, including without limitation, a paper printout, a visual display in a text form, a graphical form, or a combination, an audible signal (including, without limitation, a synthesized or recorded voice), or any combination thereof.

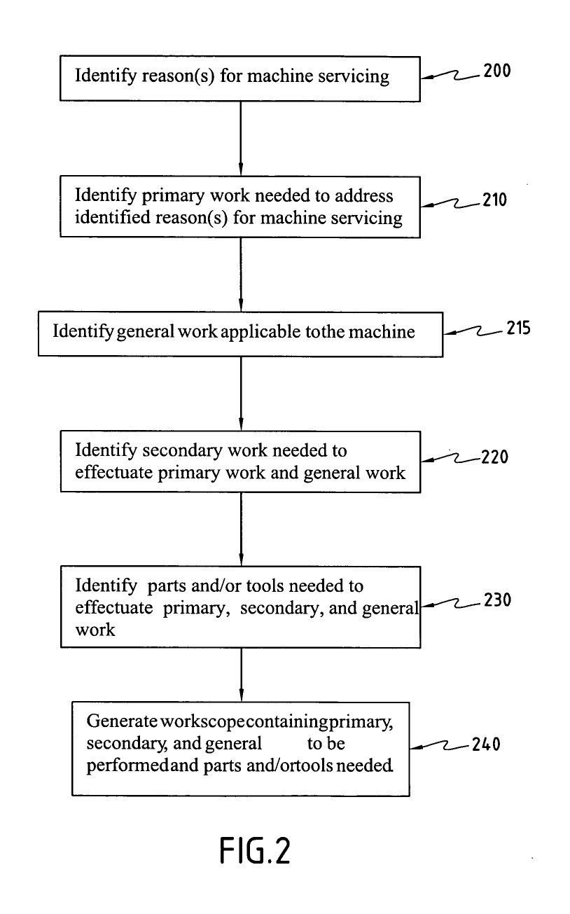

FIG. 2 illustrates a refined version of the method illustrated in FIG. 1. In general, the blocks illustrated generally correspond to their similarly numbered counterparts in FIG. 1, taking into account the change in numbering from the “100-level” to the “200-level,” and therefore a detailed explanation thereof is not repeated here.

However, block 215, located between the identification of primary work in block 210 and the identification of secondary work in block 220, is directed to identifying general work applicable to the machine. This general work most generally is work other than primary and secondary work (i.e., the work that facilitates or permits the one or more reasons for servicing the machine to be addressed). Important examples of general work are work needed to satisfy mandatory regulatory directives (e.g., airworthiness, safety, environmental, etc.) and service bulletins, and discretionary (or optional or recommended) work needed to satisfy non-mandatory service bulletins.

It is important to emphasize that general work as the term is used herein is meant to refer to work that must or should be performed during servicing, outside of the work to be performed in response to the original reason(s) for servicing the machine. That is, for example, a machine may need servicing to repair a broken component, but the work needed to satisfy a governmental safety directive for the machine would be general work, because satisfying the governmental safety directive was not the reason at the outset for servicing the machine.

It can be also appreciated that certain work that in some instances would be general work can be at other times primary work. For instance, the initial reason for servicing the machine may be to satisfy a mandatory governmental safety directive.

As indicated at 220, the identification of secondary work in this example permits the primary and general work to be performed, or permits the primary and general work to be performed more easily, efficiently, less expensively, less dangerously, etc.

The primary, secondary, and/or general work may only be applicable to a specific machine. It is therefore useful to identify a specific machine in accordance with the present invention using, for example, a serial number. Operational histories of individual machines containing standard information (e.g., age, repair history, specific parts information, operating environments, etc.) can therefore be stored and retrieved to determine if, for example, periodic maintenance work is necessary. Establishing a machine's individual identity may therefore be done before considering what primary, secondary, and general work is to be performed.

As indicated at 230 and 240, parts and/or tools for performing the primary, secondary, and general work are identified, and the generated workscope sets forth the required work and parts corresponding thereto. As before, the identification of parts and/or tools in block 230 is useful but optional according to the present invention.

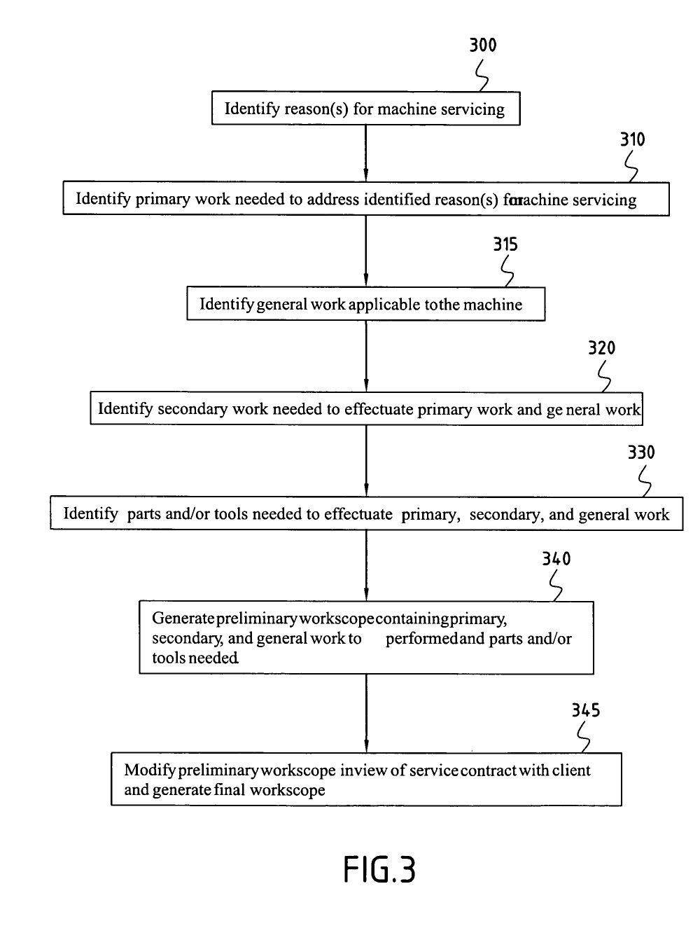

FIG. 3 is a flowchart illustrating a further refined example of the present invention.

As in FIGS. 1 and 2, the reason(s) for servicing the machine are identified at 300. Thereafter, the primary work needed to directly address the reason(s) for servicing the machine is identified at 310. As in FIG. 2, the general work applicable to the machine (whether mandatory or recommended) is identified at 315. Then, the secondary work corresponding to the primary and general work is identified at 320. As mentioned above, the secondary work permits the primary and general work to be performed, or permits the primary and general work to be performed more easily, efficiently, less expensively, less dangerously, etc. The parts and/or tools needed to carry out the primary, secondary, and general work are optionally identified at 330.

At 340, a preliminary workscope setting forth the work to be performed and the parts and/or tools needed therefor is generated. This workscope is preliminary in the sense that it is generated on a purely technical basis, without regard to non-technical factors such as client-defined requirements or other business considerations. Nevertheless, the present invention recognizes that the most desirable workscope in practice is sometimes not only controlled by technical considerations.

Accordingly, at 345, the preliminary workscope is modified in view of, for example, the terms of the client's service contract in order to generate a final workscope that is desirably tailored to the client's needs and wants. Generally, this modification could range from choosing specific service personnel to using parts and materials from certain sources to choosing (based on prior client instructions) whether or not to perform certain non-mandatory or discretionary work during service work. As mentioned above, for example, some general work (at 315) may be only recommended or is otherwise not mandatory. It may therefore be known that a given client wants or does not want such work to be performed.

For example, in the field of aviation, and more particularly, in the field of aircraft engine servicing, service contracts may be categorized as, for example, time-and-materials contracts or hours-in-air contracts. In the former example, the contract emphasizes the cost for time (i.e., labor) and materials. Therefore, it is desirable to minimize the costs therefor so as to be able to provide a competitive price for service, especially in situations where service contracts are subject to bidding and the like.

In the latter example, however, the contract is based on maximizing a time interval between servicing. In this situation, certain choices will be made in terms of the manner and materials used during servicing. For example, it may be more desirable to use somewhat more expensive parts and materials to the extent that they have a longer operational life. In another example, it may be relatively more reasonable to assume the costs for performing a scheduled maintenance item slightly ahead of schedule but concurrent with a present repair job in order to avoid a separate instance of downtime later.

In view of the time-and-materials and the hours-in-air (more broadly, hours-in-service) contract examples, it can be appreciated how external considerations generally can affect the resultant workscope in comparison to a preliminary workscope.

The modification of the preliminary workscope in block 345 can also be based on additional or other considerations, such as self-screening to avoid repeated identification of tasks.

It is emphasized that the methodologies illustrated in FIGS. 1-3 are strictly examples, and are not meant to restrictively explain the present invention. Other functions can also be provided. For example, cost information corresponding to the stored work procedures can be retrieved after generating a workscope so that a cost estimate for the forecasted work can be generated. In general, the cost will be estimated based on the costs for parts, materials, and tools, and for labor costs. As is well known, the cost factors for parts, materials, and tools can be (and, in practice, frequently are) stored and updated directly. Labor costs could be defined based on a predefinition or preselection of labor charges (e.g., a standard list of charges). Labor costs could also be estimated based on empirical knowledge about how much time is customarily needed to perform certain work. For example, as discussed below, a given workscope (and, potentially, a corresponding cost estimate) can be stored for later reference. Thus, it would be possible to average or otherwise refine a labor cost estimate for a given task or procedure in view of empirical experience.

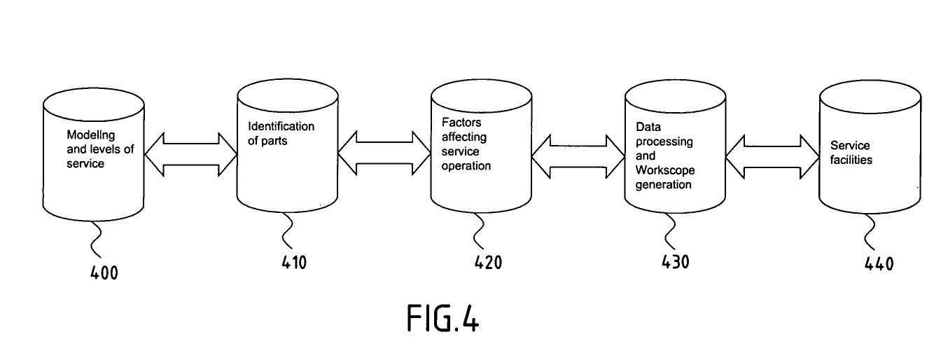

The automatic (or at least substantially automatic) operation of the present invention depends, conceptually, on the interrelationship of certain concepts as illustrated in FIG. 4: the modeling of a real machine and the types of work that can potentially be performed on that machine (400); identifying and managing parts of the machine (410); taking into account specific (i.e., case-by-case) factors that affect the final generation of a workscope (420); data processing (especially for synthesizing information from each of 400, 410, and 420) and generating a workscope (430); and providing the workscope to service facilities for use (440). With respect to FIG. 4, it is expressly noted that the illustration therein is highly schematic and meant simply to broadly illustrate the present invention and the interrelation of certain concepts rather than illustrate or define any specific structural or operational configuration. For example, the order of the elements illustrated is by way of example, as is the illustration of information exchange links therebetween. In particular, elements 400, 410, 420 could equally and validly be illustrated as being fully interconnected (e.g., element 400 is also linked with element 420).

In one example of the present invention, a given machine is modeled in terms of major modules, minor modules, subassemblies, and constituent parts. For illustrative purposes, an aircraft engine is mentioned as an example of a machine. It is emphasized, however, that the present invention is generally applicable to any machine comprising major and minor modules or assemblies and constituent subassemblies and individual parts.

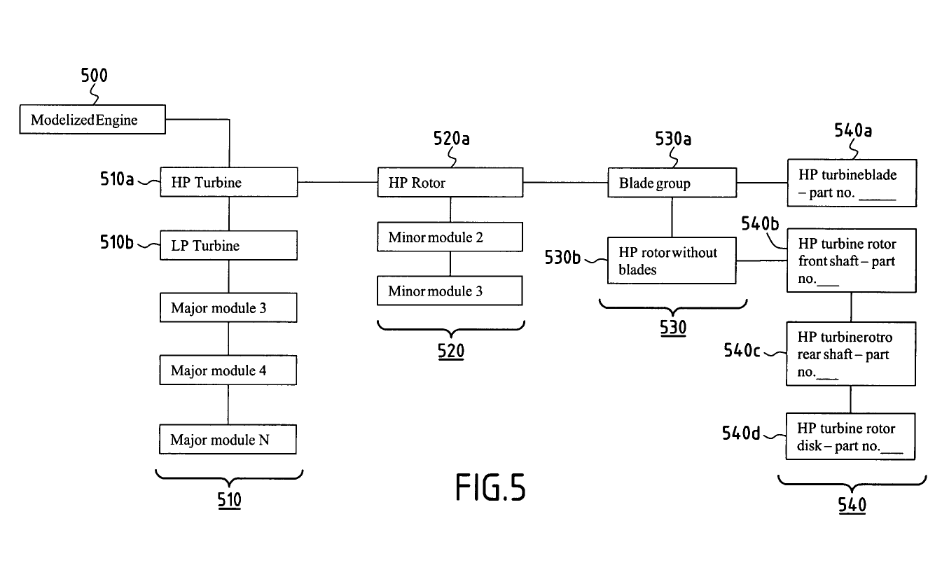

In an aircraft engine, for example, there may be 5 to 10 major modules, 10 to 25 minor modules, and 5 to 10 subassemblies in each subassembly. FIG. 5 illustrates the descending hierarchy of these relationships. In FIG. 5, a modeled engine 500 may consist at a first organizational level 510 of several major modules, including, for example, a high-pressure turbine 510a, a low-pressure turbine 510b, and several generic major modules up to major module N. In turn, a given major module may include one or more minor modules at a second hierarchical level 520. The high-pressure turbine 510a, for example, may include, in part, a high-pressure rotor 520a, as well as one or more other minor modules, generically identified here as minor modules 2 and 3. At a third hierarchical level 530, the minor modules, such as high-pressure rotor 520a, may generally be defined in terms of, for example, the group of blades 530a and the rotor 530b on which the group of blades 530a is mounted.

Hierarchical levels 500, 510, 520, and 530 as illustrated in FIG. 5 represent an example of how a machine, such as an aircraft engine, can be modeled for use in accordance with the present invention. By definition, however, the number of arrangements according to this approach is vast, and it is noted, for example, that any given level of the model may include both assemblies and individual parts.

As mentioned above, the modeled engine 500 can be linked with information reflecting the structure of the engine. In one example, the structure of the engine is arranged in a known (including, without limitation, computerized) manner as an Illustrated Parts Catalog (IPC), in which parts and assemblies and their interrelation are coded in a standardized manner so that each part and part assembly can be identified in a standard manner.

For example, as seen in FIG. 5, the identification of blades at 530a as being part of the high-pressure rotor can be linked to correspond with an appropriate blade, identified by a part number or other identifier. Likewise, the high-pressure rotor having the blades demounted therefrom at 530b may correspond in an IPC to a turbine rotor front shaft 540b, a turbine rotor rear shaft 540c, and a turbine rotor disk 540d. The rotor without blades may also be associated with a part number as an assembly.

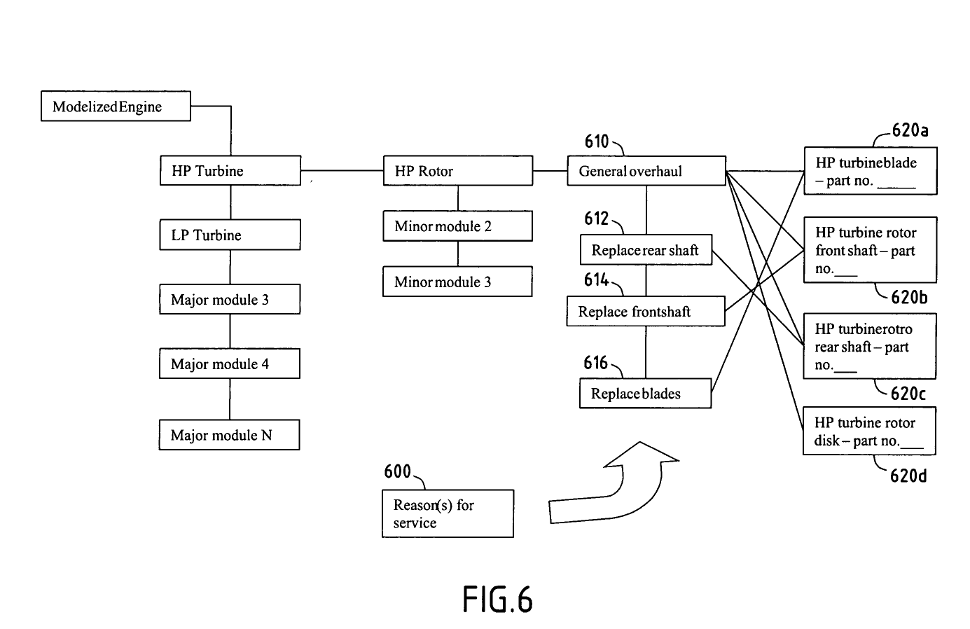

FIG. 6 is similar to FIG. 5, but illustrates an example of correlating reason(s) for servicing the engine with the model engine. Once again using just the high-pressure rotor of the high-pressure turbine as an example for the purpose of clarity, FIG. 6 illustrates that the reason(s) for engine service 600 are generally correlated with the model engine to identify what service operation(s) will be performed on the (in this case) high-pressure rotor. As illustrated here, four (for example) types of service operations are contemplated in connection with the high-pressure rotor: a general overhaul operation 610, a replacement of the rear shaft 612, a replacement of the front shaft 614, and a replacement of the rotor blades 616. The service operation(s) actually performed depends (at least in part) on the reason(s) for service 600.

Albeit in a simplified manner (for the purpose of clearly explaining the present invention), FIG. 6 illustrates how a given service operation can affect one or more corresponding parts of the machine (as was broadly noted at 410 in FIG. 4). For example, in the general overhaul operation 610, the turbine blades 620a, the front shaft 620b, the rear shaft 620c, and the rotor disk 620d all may be affected. On the other hand, replacing the rear shaft 612 may only affect the rear shaft 620c among all the parts corresponding to the high-pressure rotor. Similarly, replacing the front shaft 614 or replacing the rotor blades 616 may only affect the front shaft 620b or the blades 620a, respectively. Of course, combinations of operations may be called for (such as replacing the front and rear shafts), such that other combinations of parts of the high-pressure rotor may be affected.

As noted elsewhere, the reason(s) for service 600 may be usefully considered along with the secondary work (as defined hereinabove) that is associated a given service operation. Likewise, general work (in response to regulatory requirements and the like, for example) may also be considered. The additional consideration of secondary work and/or general work will correspondingly affect other parts of the machine but in a similar manner.

The analysis illustrated in FIGS. 5 and 6 can be affected on a case-by-case basis with regard to unique factors, such as working on a particular engine (therefore taking into account, for example, life limited parts) or working for a particular client who may have particular requirements (such as using parts made by a certain manufacturer, or contract-specific requirements like an hours-in-air cost basis rather than a time-and-materials cost basis).

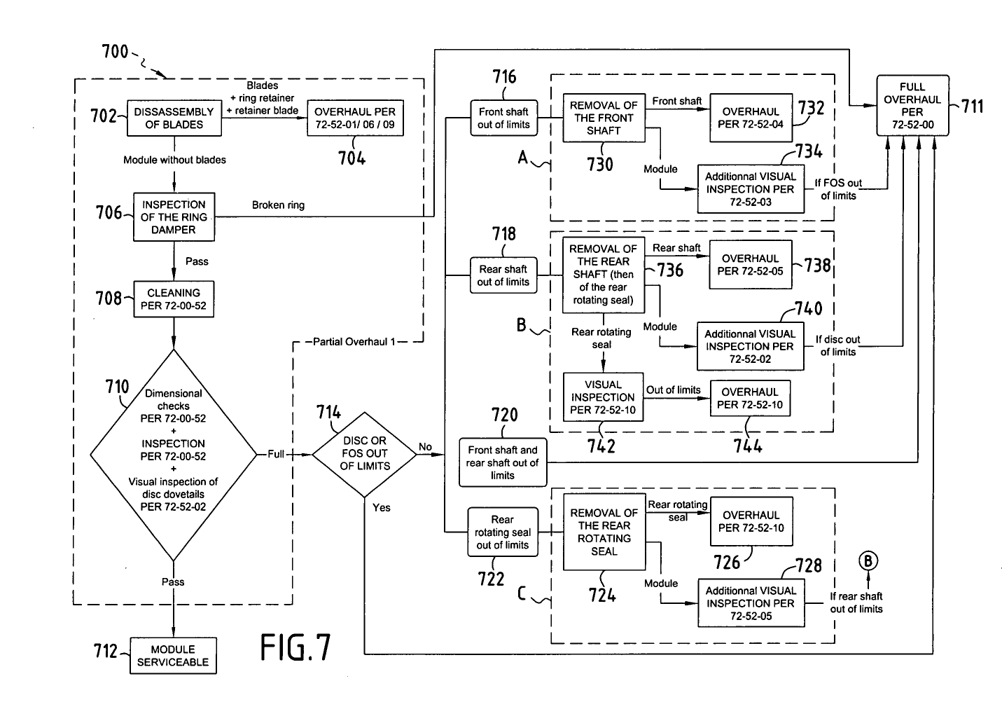

The reason(s) for service 600 may not necessarily be specifically known initially. For example, the engine may undergo a partial overhaul and inspection beforehand to determine the level of work that is needed. FIG. 7 is a flow chart illustrating an example of this kind of analysis with respect to the high-pressure turbine of an engine. It should be noted that this type of workflow represents, in a sense, a variable workscope, in that certain actions in connection with the inspection are initially specified to service personnel. Subsequent actions, however, are dictated by the results of the inspection process.

In FIG. 7, reference numeral 700 denotes a partial overhaul/inspection process for a high-pressure rotor. Initially, the process requires disassembly of the blades from the rotor at 702. The disassembled blades, the ring retainer, and the retainer blade are then overhauled according to predefined overhaul procedures denoted by example procedure numbers 72-52-01, -06, -09, respectively at 704. (The procedure numbers used herein have no specific meaning or significance other than to illustrate and provide an example of the predefinition of related or subsidiary work procedures.) The bladeless rotor module's ring module is then inspected at 706. If the ring module is in satisfactory condition, then it is cleaned in a predefined procedure at 708 (using, for example, procedure number 72-00-52). On the other hand, if the ring damper is broken, a full overhaul at 711 is required (using predefined procedure 72-52-00).

If the ring is in satisfactory condition, it undergoes predefined inspection procedures (dimensional checks, visual inspection of blade dovetails, and overall inspection) at 710. If the results of those inspections are satisfactory, then the rotor module is deemed serviceable and is processed further for reassembly at 712 with rotor blades, a ring retainer, and a retainer blade. If the results at 710 are not satisfactory on the other hand, the next step of a more thorough analysis is to determine if the rotor disc or front outer seal (“FOS”) is out of limits at 714. If so, then a full overhaul 711 is required. If the disc or FOS is not out of limits at 714, then the front and rear shafts are inspected to determine if they are out of limits (716, 718, 722), and the rear rotating seal is inspected to determine if it is out of limits (722).

If both of the front and rear shafts are out of limits (720), then a full overhaul 711 is required.

If the rear rotating seal is out of limits (722), then the rear rotating seal is removed (724) and overhauled according to predetermined procedures (726). The underlying module (comprising the front and rear shafts and the disk) is concurrently subjected to visual inspection according to predefined procedures (728), particularly in order to determine if the rear shaft is out of limits. If the rear shaft is out of limits, then the procedure branches to 718 in accordance with the procedure in an instance where the rear shaft is out of limits.

As noted above, if both the front and rear shafts are out of limits (720), then a full overhaul (711) is directly indicated. If, however, only the front shaft is out of limits (716), then the front shaft is removed (730) and subjected to overhaul according to appropriate predefined procedures (732), whereas the remaining part of the module is subject to visual inspection (734). If the FOS is out of limits based on the visual inspection at 734, then a full overhaul (711) is required.

If only the rear shaft is out of limits (718), then rear shaft and the rear rotating seal are removed (736). The rear shaft is subject to overhaul (738), and the remainder of the module and the removed rear rotating seal are subject to visual inspection (740, 742). If the visual inspection at 740 reveals that the disc is out of limits, then a full overhaul 711 is indicated. If the visual inspection of the rear rotating seal at 742 indicates that the rear rotating seal is out of limits, then the appropriate predefined overhaul at 744 is indicated.

It should be recognized that FIG. 7 represents only an example of how relevant procedure breakdowns and work flows interrelate. For example, many of the actions indicated in FIG. 7, such as overhaul procedures at 704, 711, 726, 732, 738, and 744 each represent another group of actions, and similar decision trees and work flows corresponding thereto could be illustrated. However, the nature of these interrelations can be grasped from the subject matter illustrated in FIG. 7.

The analytical process illustrated in FIG. 7 may represent a completely or partly automated process. Certain determinations (such as dimensional checks) may either be made automatically using known analytical techniques, or the processing may depend on service personnel input in response to the various decision points of the flow.

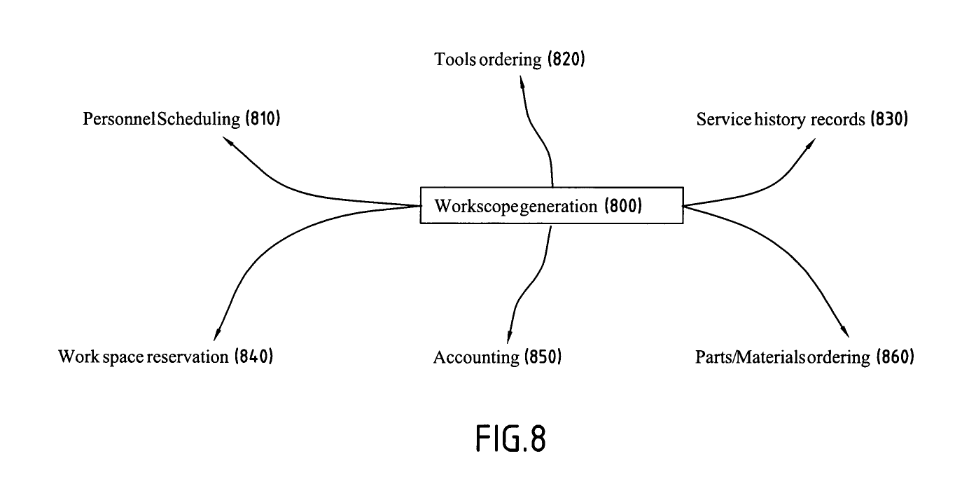

A workscope generation system 800 (an example thereof being illustrated in FIG. 9 and described below) can be useful beyond generating just workscopes, as illustrated in FIG. 8. For example, the generated workscope can be provided to a human resources department or the like in order to manage personnel scheduling 810. Indeed, a collection of workscope information could be even more generally used to project personnel hiring needs for a service facility.

As mentioned above, a workscope according to the present invention may usefully identify tools that are needed to carry out the work set forth in the workscope 820. This information could be used to ensure that service personnel have those tools available when working according to the workscope, such that no time is wasted searching for a needed tool. In another example, the tool information could be used to form job-specific tool kits. Also, the tool information could be used for inventory management or asset control.

As indicated at 830, service histories for a plurality of individual machines may be generated and stored. Thus, a new workscope for a given machine could be appended to the machine's service history or could otherwise form the basis for an update of the service history. Also, as mentioned above, the present invention contemplates using a machine's service history as one basis for generating a current workscope (e.g., in order to determine if scheduled maintenance is due).

As indicated at 840, the workscope could be used to control workspace allotment within the service facility, especially if some work must be performed in a specific area of the service facility (which is, for example, specially outfitted). More broadly, the workscope could be used as a factor in scheduling entire service projects, such that it can be known whether facility space, time, and personnel (see 810) are available.

Workscope information could be provided to a service facility's accounting department, as indicated at 850. For example, the cost estimates generated as part of a workscope can be suitably and efficiently converted into invoices. Also, the workscopes may provide useful information relevant to payroll matters, such as forecasting personnel labor hours.

Similar to order tools at 820, the workscopes can be used to manage parts and material orders, as seen at 860. In a particular example, the workscopes can form the basis for a just-in-time (JIT) parts and material supply system. As is known in the art, a JIT supply system is based on ordering essentially only the parts and materials that are needed at any given time in view of work to be performed. This is economically advantageous in that a service facility can minimize expending financial resources on parts and materials that may not be used for long periods of time, such that the service facility cannot reap a financial benefit from client billing. In addition, a JIT system reduces logistical costs for the service facility, such as storage and security.

It is strongly emphasized that the diagram shown in FIG. 8 is not at all exhaustive. However, the examples set forth therein clearly illustrate that the present invention can and is intended to contribute to the efficiency of various parts of a service facility, and not just in terms of actual work performed on a machine. In addition, the workscope itself can be used directly for other applications (such as the examples illustrated in FIG. 8), or it can be processed further according to conventional data processing practices to produce an end result particularly useful for a given application (such as the examples illustrated in FIG. 8). In one example of such conventional data processing practices, the workscope has a data structure of data entry record comprising a plurality of identifiable data fields. Thus, for example, cost estimate data can be automatically extracted from the generated workscope (since the data fields containing that information are known to the system) and provided to an accounting department 850 so that it has only the information it can beneficially use, without being troubled to manually retrieve the information that is relevant.

FIG. 9 illustrates an example of a system according to the present invention. FIG. 9 is meant to schematically illustrate a computer network 900 including one or more servers 910 (only one server being illustrated here by way of example), connected to a plurality of workstation terminals 920. The terminals 920 may be, for example and without limitation, conventional PC workstations connected to the server(s) 910 according to conventional networking mechanisms (including, without limitation, wireless networking), or handheld data terminals (sometimes conventionally known as Personal Data Assistants or PDAs) that may in particular be connected to the server(s) 910 using conventional wireless data communication technology so as to offer service personnel mobility. Simple keypads or touchscreens could also be used as terminals 920. The use of handheld terminals may be useful in order to permit service personnel to move about a service facility freely (especially in order to move about a machine being serviced). The terminals 920 are used to generally interact with the system 900, including to enter reason(s) for service and machine identification, and to display a resultant workscope and cost estimate information.

The network 900 may of course include usual computer peripherals such as printers (for example, for printing out workscopes) and monitors (for example, for displaying a series of work actions to be performed), although such are not illustrated here.

The network 900 may be configured as a Local Area Network (LAN) within a given service facility. However, the network may, for example, be configured as a Wide Area Network (WAN) or Virtual Private Network (VPN) in a conventional manner, depending on a physical layout of a service facility and/or depending on the relationships between a service facility and, for example, its supply sources and/or its customers. In one example, the network in a service facility may be connected by conventional data communication mechanisms with the data network of a third-party supply vendor (e.g., to further facilitate supply ordering). The network in a service facility may also be connected in a known manner with a customer facility, so that cost (including cost estimates for machine servicing) and technical information can be exchanged therebetween.

In general, the one or more servers 910 store one or more computerized databases and operate the software for generating a workscope in accordance with the present invention. Generally, the one or more databases store structural information about a machine and servicing information about the machine, including repair and maintenance procedures relevant to the machine. Preferably, the one or more databases also store predefined reasons for servicing the machine, each predefined reason being linked by conventional database mechanisms to primary work corresponding thereto, especially one or more corresponding repair and/or maintenance procedures. Thus, in practice, when a given machine is serviced, the reason or reasons for service are input (for example, by keying a keyboard of a terminal 920), and, in general, the primary work needed to address those reason(s) for service is output. It is useful to use predefined reasons for service, partly in order to facilitate database links between each predefined reason for service and the corresponding work needed to address that reason. It is therefore useful to predefine a reasonably broad range of reasons for service.

The one or more servers 910 also may store secondary work, which is work that does not necessarily directly address the reason(s) for service, but which facilitates the primary work or even permits the primary work to be completed. The secondary work is linked by conventional database mechanisms to the primary work, and possibly also to the reasons for service. The one or more servers 910 may also or alternatively store (on a periodically updated basis, for example) information corresponding to manufacturer service bulletins or regulatory airworthiness directives. In this latter case, the network 900 may alternatively be constructed to as to receive, automatically or otherwise, current service bulletin and/or regulatory information from an exterior network, including, without limitation, the Internet.

The one or more servers 910 may also store parts and/or tool information that is linked by conventional database mechanisms to the primary and secondary work information, such that for any given primary or secondary work the involved parts of the machine and/or the required tools to be used can be known. (Here, consumable “materials” (such as solvents, paints, polishes, etc.) may be considered within the idea of parts.) In one example, the parts information may be usefully organized in a stacked hierarchy of levels, ranging from, for example, the complete machine, constituent assemblies of the machine, the constituent subassemblies of the respective assemblies, down to the individual parts, such as wiring, bolts, seals, etc. In a particular example, the multi-layered organization of the parts information may be in the form of a computerized Illustrated Part Catalog (IPC) as is known in the art. In general, IPCs contain visual representations of parts as well as how parts (or subassemblies or assemblies) interrelate. Such visual representations may be additionally included as part of the generated workscope in order to visually illustrate the work to be performed.

As mentioned above, the network 900 may usefully include a terminal 920 located at a parts supply and/or a tool supply, such that the needed parts (and materials) and/or tools can be gathered or ordered once the need therefor is established by the generation of a workscope. For example, a requisition corresponding to the generated workscope could be generated and transmitted via the network (by, for example, email, SMS, fax, etc.) to a supply room or even to a third-party supply vendor.

The one or more servers including databases 510 may also store operational histories for one or more different specific machines, especially including past service history and corresponding maintenance schedules. This information may be arranged, for example, according to a machine's serial number, or any other conventional and machine-specific identifier. It will be appreciated that among different individual machines of a given type (e.g., aircraft engines), each machine has a different operational history (with regard to, for example, age, operating environment, operating loads, servicing history, etc.) Different individual machines can be distinguished by inputting a machine identification such as a serial number or the like. Based on the operational history for a given machine, work specific to that machine can be identified, such as age-specific maintenance (e.g., changing a turbine blade assembly after a certain number of flight cycles). In addition, specific parts in a specific machine could be tracked.

In another example, the system according to the present invention could be completely constituted by a single PC computer (not shown) running appropriate computer readable program code, with or without helpful peripherals, such as printers.

While the present invention has been described with respect to what are believed to be the most practical embodiments thereof, it is particularly noted that this is by way of example only, and appropriate modifications and variations thereof are possible within the spirit and scope of the claims appended hereto.

What is claimed is:

1. A system for managing service of a machine, comprising:
at least one database for storing:
structural information about the machine;
servicing information relevant to the machine, including at least repair procedures and maintenance procedures relevant to the machine; and
at least one predefined reason for servicing the machine, the stored at least one reason for servicing the machine being linked to at least one of the stored repair procedures and stored maintenance procedures;
an interface for selecting at least one of the stored reasons for servicing the machine; and
a processor constructed and arranged to automatically generate a workscope of work to be performed on the machine, the workscope including one or more of the repair and maintenance procedures selected on the basis of the selected at least one reason for servicing the machine.

2. The system according to claim 1, wherein the at least one database further stores secondary work information corresponding to at least some of the stored repair and maintenance procedures, the secondary work information comprising work that must or should be performed in conjunction with a given stored repair or maintenance procedure, wherein the processor is further constructed and arranged to automatically include in the workscope the secondary work information corresponding to each of the one or more of the selected repair and maintenance procedures.

3. The system according to claim 1, wherein the stored structural information includes machine parts information, the processor being further constructed and arranged to automatically identify any machine part needed in order perform the selected one or more repair and maintenance procedures included in the workscope.

4. The system according to claim 1, wherein the at least one database stores tool information corresponding to the repair and maintenance procedures, the processor being further constructed and arranged to automatically identify any tool necessary for performing the selected one or more repair and maintenance procedures included in the workscope.

5. The system according to claim 2, wherein the at least one database stores cost information corresponding to the repair and maintenance procedures, the processor being further constructed and arranged to automatically determine an estimated cost for performing the selected one or more repair and maintenance procedures included in the workscope.

6. The system according to claim 5, wherein the cost information comprises labor cost information.

7. The system according to claim 6, wherein the labor cost information is empirically based.

8. The system according to claim 5, wherein the at least one database stores client-specific requirements, the processor being constructed and arranged to automatically modify the cost estimate in accordance with the client-specific requirements.

9. The system according to claim 8, wherein the client-specific requirements comprises client contract-defined requirements.

10. The system according to claim 9, wherein the machine is an aircraft engine and the client contract is one of an hours-in-air contract and a time-and-materials contract.

11. The system according to claim 3, further comprising means for requesting the needed machine parts from a machine parts supply source.

12. The system according to claim 4, further comprising means for requesting the needed tools from a tool supply source.

13. The system according to claim 5, further comprising means for transmitting the estimated cost to a client.

14. The system according to claim 3, wherein the at least one database stores tool information corresponding to the repair and maintenance procedures, the processor being further constructed and arranged to automatically identify any tool necessary for performing the selected one or more repair and maintenance procedures included in the workscope,
wherein the at least one database stores cost information corresponding to the repair and maintenance procedures, the machine parts information, and the tool information,
the processor being further constructed and arranged to automatically determine an estimated cost for performing the selected one or more repair and maintenance procedures included in the workscope, including the corresponding tools and parts therefor.

15. The system according to claim 1, comprising means for identifying non-critical machine service related to the selected one or more repair and maintenance procedures included in the workscope, the processor being further constructed and arranged to include the identified non-critical service in the workscope.

16. The system according to claim 1, wherein the at least one database stores an operational history of the machine, the operational history including a service history of the machine.

17. The system according to claim 16, wherein the interface is additionally for inputting a machine identification so that the operational history of the machine can be obtained.

18. The system according to claim 17, comprising means for identifying non-critical machine service related to the service history of the machine.

19. The system according to claim 3, wherein the stored machine parts information is organized in an Illustrated Part Catalog.

20. The system according to claim 1, wherein the interface comprises one or more of a keyboard, a keypad, a touchscreen, and a personal data assistant.

21. The system according to claim 10, wherein the processor is constructed and arranged to generate a workscope using minimal material and labor for a time-and-materials contract.

22. The system according to claim 10, wherein the machine is an aircraft engine, and the processor is constructed and arranged to generate a workscope estimated to maximize a time period between servicing in a hours-in-air contract.

23. The system according to claim 1, wherein the at least one database, the interface, and the processor are embodied in a PC computer.

24. The system according to claim 1 wherein the at least one database and the processor are embodied in at least one computer network server and the interface is embodied in a workstation computer located on the computer network.

25. A method of managing machine servicing, comprising:
identifying one or more reasons for servicing the machine;
based on the identified one or more reasons for servicing, identifying required primary work needed to address the identified one or more reasons for servicing;
generating a workscope defining the work to be performed on the machine, including at least the identified primary work.

26. The method according to claim 25, wherein identifying primary work needed to address the identified one or more reasons for servicing comprises identifying stored repair and/or maintenance procedures corresponding to the identified one or more reasons for servicing.

27. The method according to claim 26, further comprising identifying required secondary work corresponding to the identified primary work, wherein the generated workscope further includes the identified secondary work.

28. The method according to claim 27, further comprising identifying machine parts corresponding to the identified primary and secondary work, wherein the generated workscope includes the identified machine parts.

29. The method according to claim 27, further comprising identifying tools corresponding to the identified primary and secondary work, wherein the generated workscope includes the identified tools.

30. The method according to claim 27, further comprising generating a cost estimate for the identified primary and secondary work.

31. The method according to claim 30, wherein generating a cost estimate comprises modifying an initial cost estimate in view of client contract requirements.

32. The method according to claim 31, wherein the machine is an aircraft engine and the client contract is one of an hours-in-air contract and a time-and-materials contract.

33. The method according to claim 32, wherein modifying the initial cost estimate in view of an hours-in-air contract includes generating a workscope estimated to maximize a time interval between servicing performed on the aircraft engine.

34. The method according to claim 32, wherein modifying the initial cost estimate in view of a time-and-materials contract includes selecting a workscope estimated to minimize time and materials expended during servicing.

35. The method according to claim 25, wherein identifying the primary work needed to address the identified one or more reasons for servicing is additionally based on an operational history of the machine.

36. The method according to claim 35, further including identifying recommended work based upon the operational history of the machine, wherein the workscope further includes the recommended work.

37. The method according to claim 36, wherein identifying recommended work comprises identifying recommended work based on an operational age of the machine.

38. The method according to claim 36, wherein identifying recommended work comprises identifying recommended work based on an operating environment of the machine.

39. The method according to claim 36, wherein identifying recommended work comprises identifying recommended work based on a frequency of operation of the machine.

40. The method according to claim 39, wherein the machine is an aircraft engine and the frequency of operation of the aircraft engine is measured in terms of flight cycles.

41. The method according to claim 37, wherein the machine is an aircraft engine and the operational age of the aircraft engine is measured in terms of hours of operation.

42. The method according to claim 28, further comprising generating a request for the identified machine parts.

43. The method according to claim 29, further comprising generating a request for the identified tools.

44. The method according to claim 30, wherein the cost estimate includes one or more of a cost for parts, a cost labor, and a cost for materials.

45. The method according to claim 30, wherein generating a cost estimate comprises using empirical cost data to generate the cost estimate.

46. The method according to claim 25, further comprising identifying required general work unrelated to the primary and secondary work, wherein the generated workscope includes the required general work.

47. The method according to claim 46, wherein identifying the general work comprises identifying servicing required by governmental regulations.

48. The method according to claim 47, wherein the general work is defined with respect to an operational age of the machine.

49. The method according to claim 46, wherein identifying the general work comprises identifying manufacturer-defined maintenance and/or repair procedures.

50. The method according to claim 27, further comprising filtering out repetitive and/or redundant work actions constituting the primary and secondary work, the workscope comprising the filtered primary and secondary work.

51. An article of manufacture comprising:
a computer-readable medium having computer readable program code thereon for enabling the automatic management of machine servicing, the computer-readable program code comprising:
identifying one or more reasons for servicing the machine;
based on the one or more reasons for servicing the machine, identifying all work procedures for addressing the one or more reasons for servicing the machine;
generating a workscope including the identified work procedures.

52. A method of managing service performed on a client's aircraft engine, the method comprising:
identifying one or more reasons for servicing the engine;
identifying work procedures corresponding to the one or more identified reasons for servicing the engine;
narrowing the identified work procedures in accordance with client-specific requirements to obtain a client-specific set of work procedures corresponding to the one or more reasons for servicing the engine;
identifying pending general work procedures applicable to the engine;
narrowing the pending general work procedures down to identify required general work procedures and discretionary general work procedures desired by the client to obtain a client-specific set of general work procedures;
combining the client-specific set of work procedures corresponding to the one or more reasons for servicing the engine and the client-specific set of general work procedures to obtain a combined client-specific set of work procedures;
eliminating redundant and/or repeated work procedures from the combined client-specific set of work procedures;
identifying complimentary work procedures corresponding to the combined client-specific set of work procedures;
identifying the engine parts affected by the combined client-specific set of work procedures and the identified complimentary work procedures; and
generating a workscope comprising the combined client-specific set of work procedures, the identified complimentary work procedures, and the affected engine parts.

53. The method according to claim 52, wherein the general work procedures are defined by regulatory notices.

54. The method according to claim 53, wherein the regulatory notices comprise airworthiness directives.

55. The method according to claim 52, wherein the general work procedures are defined by manufacturer service bulletins.

56. The method according to claim 52, further comprising identifying tools needed to carry out the combined client-specific set of work procedures and the identified complimentary work procedures, wherein generating a workscope further comprises the identified tools.

57. The method according to claim 52, further identifying an estimated cost for the combined client-specific set of work procedures, the identified complimentary work procedures, and the affected engine parts, wherein the workscope comprises the combined client-specific set of work procedures, the identified complimentary work procedures, and the estimated cost therefor.

58. The method according to claim 52, wherein identifying pending general work procedures is at least partly based on an operational history of an individual engine.

59. The method according to claim 58, wherein the operational history of an individual engine comprises a predominant operating environment.

60. The method according to claim 58, wherein the operational history of an individual engine comprises engine age.

61. The method according to claim 60, wherein engine age is measured in terms of operating hours.

62. The method according to claim 60, wherein engine age is measured in terms of flight cycles.
